(19) United States
(12) Patent Application Publication
(10) Pub. No.: US 2009/0128921 A1
(43) Pub. Date: May 21, 2009

(54) LED COLLIMATOR HAVING SPLINE SURFACES AND RELATED METHODS

(75) Inventor: Eric A. Roth, Gloucester, MA (US)

Correspondence Address: Philips Intellectual Property and Standards, P.O. Box 3001, Briarcliff Manor, NY, 10510-8001, US

(73) Assignee: Philips Solid-State Lighting Solutions, Burlington, MA (US)

(21) Appl. No.: 11/940,926

(22) Filed: Nov. 15, 2007

(51) Int. Cl. G02B 27/30

(52) U.S. Cl. 359/641

(57) ABSTRACT

A TIR collimator for an LED light source includes a body portion having a reflective surface, wherein the reflective surface includes a plurality of segments. Respective segments of the reflective surface have corresponding cross-sectional profiles defined by different low-order polynomial functions, such that the overall cross-sectional profile of the reflective surface constitutes a spline, i.e., a piecewise polynomial function. The respective segments are configured to achieve substantial collimation of the output light. In one example, the cross-sectional profiles of adjacent segments of the reflective surface are defined by different low-order polynomials. Additionally, two or more adjacent segments may have respective cross-sectional profiles which together are defined by a Bezier curve, so as to provide smooth transitions between adjacent segments of the spline reflective surface.

### FIELD OF THE INVENTION

The present invention generally relates to optical structures for capturing and directing light from a light source and, more particularly, to collimators for LED light sources and LED-based luminaires employing these collimators.

### BACKGROUND

Collimated light is light whose rays are parallel and thus has a planar wavefront. Optical structures for collimating visible light, often referred to as “collimator lenses” or “collimators,” are known in the art. These structures capture and redirect light emitted by a light source to improve its directionality. One such collimator is a total internal reflection (“TIR”) collimator. A TIR collimator includes a reflective inner surface that is positioned to capture much of the light emitted by a light source subtended by the collimator. The reflective surface of conventional TIR collimators is typically conical, that is, derived from a parabolic, elliptical, or hyperbolic curve.

Referring to FIG. 1, a conventional TIR collimator 100 collects the light emitted by an LED light source 112 and directs the light so that it exits the collimator at a top portion 113. Some of the light travels from source 112 through a primary optic 114, into a first cavity 116, through a centrally-located lens 118, and out via a second cavity 120. The remainder of the light exits via a transparent surface 122 or a flange 124, which is used to retain collimator 100 in a holder (not shown). The light that does not pass through the central lens is incident on an inner sidewall 126 and is refracted as it passes from the air in the first cavity into the plastic material of the collimator. Thereafter, it is reflected at an inner reflective surface 129. The reflected light is refracted again as it travels from the plastic body of the collimator to the ambient air, at transparent surface 122. The reflective surface is conical, so that a cross-sectional profile of the collimator is parabolic at the reflective surface, as shown in FIG. 1.

The reflection at reflective surface 129 occurs by total internal reflection, establishing constraints on the overall shape and curvature of the cross-sectional profile of the reflective surface. Due to the difference between the refractive index of collimator 100 and the refractive index of the ambient air, Snell's law applies and defines a critical angle for the angle of incidence, which is made by an incident light ray with respect to a normal to the reflective surface. That is, for incident angles above the critical angle, all of the light is reflected and none is transmitted through the reflective surface 129 or along the surface 129, thereby providing total internal reflection. For a plastic (refractive index of about 1.59)-air (refractive index of 1) interface, the critical angle is about 39 degrees. Thus, the reflective surface 129 is sloped to provide an angle of incidence for most of the light that is greater than about 39 degrees.

In theory, conventional collimators are capable of producing perfectly collimated light from an ideal point source at the focus. However, when these collimators are used in real-life applications with a light source of an appreciable surface area (such as an LED light source), the light is not completely collimated but, rather is directed into a diverging conic beam. Conventional collimators have little room for additional components for adjusting the directionality of the light. Furthermore, design factors relating to an LED light fixture in which one or more collimators may be employed often set constraints on the size of the collimator, so that the size can only be adjusted to a limited extent in order to improve (e.g., reduce) beam divergence.

Another drawback of conventional LED collimators is that some uncollimated light can escape at flange 124 or similar retaining structure, resulting in the formation of undesirable light rings in the light pattern. One known method for addressing this problem is to adjust the angle of inclination of transparent surface 122. However, such an approach may increase beam divergence properties.

Certain recent improvements in conventional collimators, such as depicted in FIG. 1, are described in U.S. Pat. No. 6,547,423, entitled “LED Collimation Optics with Improved Performance and Reduced Size” (the '423 patent), which is hereby incorporated by reference herein. The '423 patent discloses an LED collimator directed to improving light collimation and uniformity properties by adjusting orientation of its inner sidewall and making corresponding adjustments to the reflective surface. The surfaces are defined point-by-point starting at some maximum polar angle made by light rays with respect to the optic axis (e.g., 90 degrees with respect to the optic axis) and proceeding up to some minimum polar angle.

Thus, there exists a need in the art for a collimator with reduced beam divergence angle, as well as improved spatial uniformity of the exit beam and light extraction efficiency. In addition, it is desirable to reduce overall height and the exit aperture diameter of such a collimator to provide more flexibility in luminaire design, leading to improvements in various illumination and direct-view applications employing LED light sources. Further, it is desirable to provide a collimator that can be designed using conventional, off-the-shelf design software and manufactured with optimal reproducibility and yields.

### SUMMARY OF THE INVENTION

Applicant herein has recognized and appreciated that one or more of the desirable characteristics of the collimator mentioned above can be realized without sacrificing performance in other areas by providing a collimator having one or more surfaces having a spline profile, such as a reflective spline surface, configured to account for angular errors resulting from the finite size of the light source. Thus, a lighting apparatus and collimator for an LED light source according to various implementations and embodiments of the present invention exhibit improved collimation and beam divergence properties, as well as a uniform light pattern. Furthermore, the collimator can be fabricated using off-the-shelf design software and relatively simple manufacturing techniques, thereby providing optimal reproducibility and high manufacturing yields.

Generally, in one aspect, the invention relates to a collimator for an LED light source that includes: (i) an inner sidewall for receiving and refracting light generated by the LED light source; (ii) a first outer wall for receiving and reflecting the light refracted at the inner sidewall, and (iii) a second outer wall for receiving and transmitting the light reflected from the spline reflective surface. The first outer wall includes a spline reflective surface having a cross-sectional profile at least partially defined by a spline. The spline is a piecewise polynomial function including a first low-order polynomial and a second low-order polynomial different from the first low-order polynomial. The first and second low-order polynomials are selected to achieve substantial collimation of the light reflected from the spline reflective surface.

In another aspect, the invention relates to a lighting module, which includes at least one LED light source and a collimator disposed to receive light emitted by the LED light source. The collimator includes: (i) an inner sidewall for receiving and refracting light generated by the LED light source; (ii) a first outer wall for receiving and reflecting the light refracted at the inner sidewall; and (iii) a second outer wall for receiving and transmitting the light reflected from the spline reflective surface. The first outer wall includes a spline reflective surface having a cross-sectional profile at least partially defined by a spline. The spline is a piecewise polynomial function including a first low-order polynomial and a second low-order polynomial different from the first low-order polynomial. The first and second low-order polynomials are selected to achieve substantial collimation of the light reflected from the spline reflective surface.

In yet another aspect, the invention relates to a collimator for an LED light source and for emitting a collimator output light, the collimator including body portion and a lens contiguous with and surrounded by the body portion. The body portion has: (i) an inner sidewall disposed to receive and refract the light generated by the LED light source, the inner sidewall at least partially defining a cavity; (ii) a first outer wall for receiving and reflecting the light refracted at the inner sidewall, the first outer wall including a TIR spline surface having a plurality of sub-surfaces; and (iii) a second outer wall for receiving and transmitting the light reflected from the TIR spline surface. The lens has an inner surface further defining the cavity. A first portion of the collimator output light exits the collimator at the second outer wall, and the plurality of sub-surfaces of the TIR spline surface are configured to cause the first portion of the collimator output light to be substantially parallel to a central axis of the body portion.

In yet a further aspect, the invention relates to a collimator for an LED light source and for emitting a collimator output light. The collimator has a body portion having a central axis and including: (i) a first inner sidewall at least partially defining a first cavity and centrally disposed to receive and refract light from the LED light source, the first inner sidewall being disposed at an angle ranging from about 50 to about 45° from the central axis; (ii) a first outer wall disposed to receive and reflect light refracted at the first inner sidewall, the first outer wall including a spline reflective surface having a plurality of sub-surfaces including at least one pair of adjacent sub-surfaces defined by different low-order polynomials; (iii) a second outer wall including a transparent surface for receiving and transmitting light reflected from the spline reflective surface; (iv) a flange contiguous with the transparent surface and at least partially encircling the transparent surface; and (v) a second inner sidewall contiguous with the second outer wall and at least partially defining a second cavity. A first portion of the collimator output light exits the collimator at the second outer wall, and the plurality of sub-surfaces of the spline reflective surface are configured to cause the first portion of the collimator output light to be substantially parallel to the central axis. The collimator further has a lens contiguous with and surrounded by the body portion. The lens has an inner surface further defining the first cavity and an outer surface further defining the second cavity. A second portion of the collimator output light exits the collimator at the outer surface of the lens, and the lens is configured to cause the second portion of the collimator output light to be substantially parallel to the central axis.

In another aspect, the invention relates to a method for configuring a collimator for an LED light source, the collimator having a reflective surface. The method includes the acts of: (i) defining an inner sidewall disposed at an angle ranging from about 5° to about 45° from a central axis of the collimator for receiving and refracting light from the LED light source; (ii) defining a conic TIR reflective surface for receiving and reflecting light from the inner sidewall; (iii) dividing a cross-section of the conic TIR reflective surface into a plurality of segments, each of the segments having a center point and a tangent to the segment at the center point; (iv) adjusting each tangent to cause a light ray originating at the inner sidewall and incident on the corresponding center point to exit the collimator substantially parallel to the central axis of the collimator, thereby defining an adjusted tangent for each of the plurality of segments; and (v) generating a spline curve passing through the plurality of center points and constrained by the plurality of adjusted tangents.

In yet another aspect, the invention relates to a collimator for an LED light source manufactured by the method described immediately above.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED light sources as discussed above, alone or in combination with other non LED light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a cross-sectional view of a conventional LED collimator in which an outer reflective surface of the collimator has a parabolic cross-sectional profile;

FIG. 2 is a schematic cross-sectional view of an LED light source with a collimator according to some embodiments of the invention;

FIG. 3 is a cross-sectional view of a collimator, similar to that shown in FIGS. 1 and 2, to facilitate an explanation of a method for modifying a conventional collimator to provide an improved collimator according to one embodiment of the present invention;

FIG. 4 is a close-up view of a portion of a reflective surface of a collimator to facilitate an explanation of a method for improving smoothness of the reflective surface by employing a Bezier curve for at least a portion of the reflective surface's cross-sectional profile, according to one embodiment of the present invention; and

FIG. 5 is a diagram illustrating various concepts in connection with a method for fabricating a collimator according to one embodiment of the present invention.

### DETAILED DESCRIPTION

A collimator in accordance with the various embodiments and implementations of the invention is a fully-integrated, low-profile optical structure, which is easily manufactured in a highly reproducible manner. Its improved collimating functionalities are achieved without requiring additional hardware or space, enabling higher densities of LED light sources in a lighting apparatus employing one or more collimators according to the present invention. This, in turn, leads to improved light mixing properties and greater control of the light output of such apparatus and adds another degree of freedom or useful variable(s) to the system.

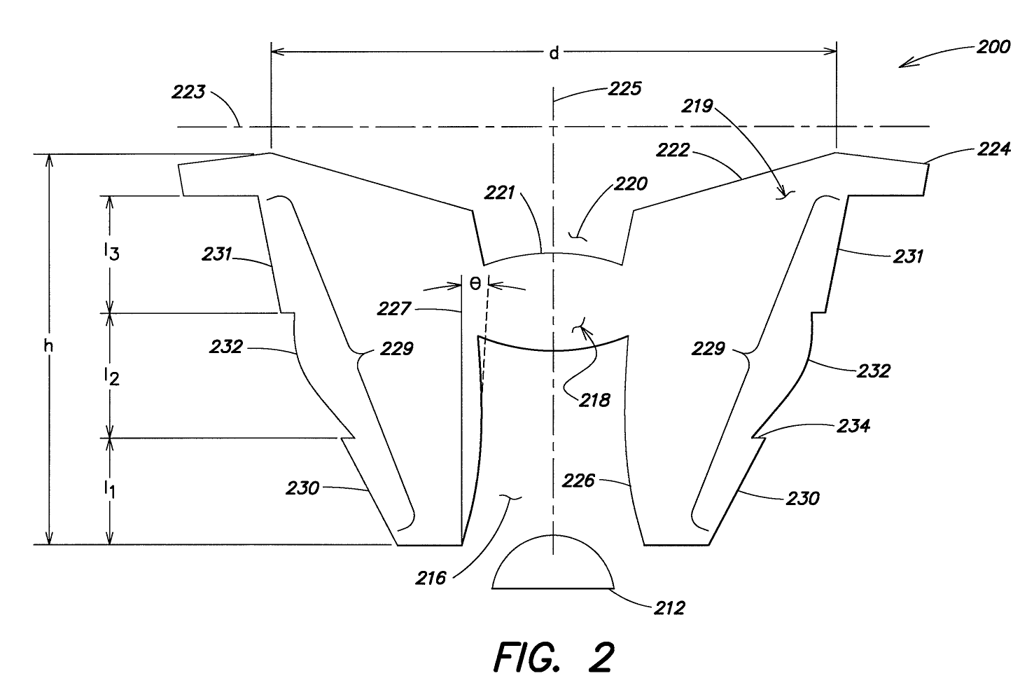

Referring to FIG. 2, a collimator 200 in accordance with various embodiments of the present invention is disposed to receive light emitted by an LED light source 212. In general, the light source and collimator provide collimated light for a lighting apparatus employing these elements. In one exemplary implementation, the collimator is generally conical in nature, and can be made by injection molding using a moldable, transparent material, such as a polycarbonate. As can be seen in the cross-sectional view illustrated in FIG. 2, the collimator 200 is generally symmetrical in vertical cross-section, and includes a body portion 219 that is symmetrical about a central axis 225 (i.e., the generally conical shape of the collimator results from rotating the cross-section shown in FIG. 2 about the central axis 225). Accordingly, unless otherwise indicated, it should be assumed that any discussion below in connection a particular feature found in one half of the cross-section of the body portion 219 likewise applies to a corresponding feature in the other half of the cross-section of the body portion shown in FIG. 2.

With respect to the functionality of the collimator 200, at least a portion of light emitted by the light source 212 travels into a first cavity 216. Some of this light thereafter travels through a lens 218, which is contiguous with and surrounded by the body portion 219. In one embodiment, the percentage of the light emitted by the light source which impinges upon the lens 218 is about 30%. The light that travels through the lens exits the lens into a second cavity 220 after being refracted at an outer surface 221 of the lens. The lens is shaped to cause the light exiting therefrom to be substantially parallel to the central axis 225 of the body portion 219. In various embodiments of the invention, the outer surface of the lens is a texturized surface, which is useful in applications in which greater light blending is desired. Methods for texturizing the outer surface of the lens include chemical etching and sand blasting.

Much of the light that does not travel through the lens 218 exits the collimator at a second outer wall 222. In the exemplary collimator shown in FIG. 2, a profile of the second outer wall 222 is not exactly perpendicular to the central axis 225, such that the second outer wall forms a funnel-like shape in the top of the collimator. In other embodiments of the invention, the second outer wall 222 can be co-planar with a flange 224 and/or the outer surface 221 of the lens.

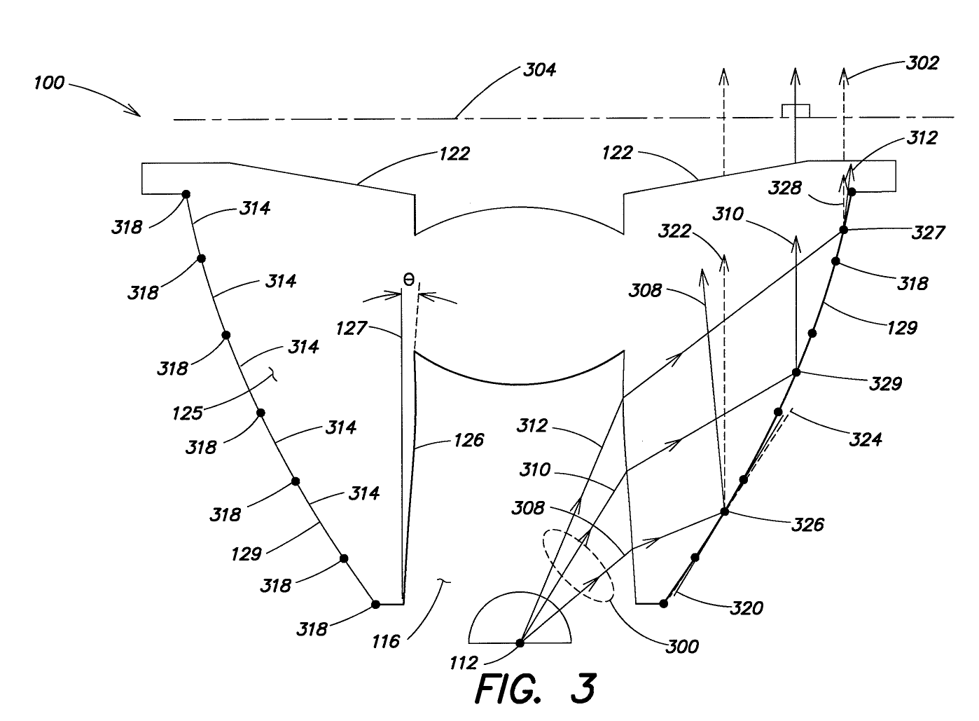

The collimator 200 shown in FIG. 2 is highly effective at collimating the light generated by the LED light source 212. That is, the collimator causes the light that exits the lens 218 and the second outer wall 222 to be perpendicular to an exit plane 223, just above the collimator. Stated another way, the collimator causes the exiting light to be substantially parallel to the central axis 225 of the body portion 219. The collimation of the light travelling through the body portion 219 is described in greater detail below in connection with FIG. 3.

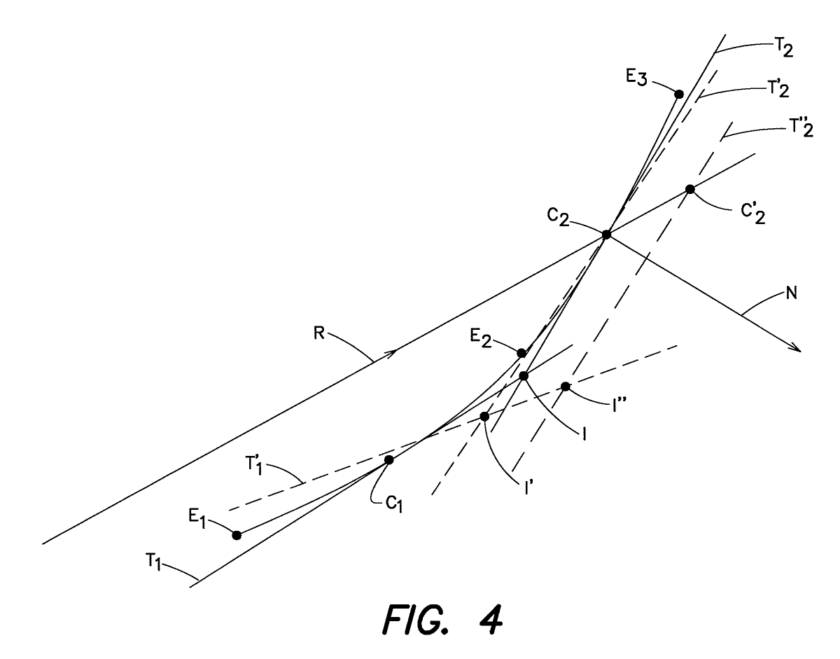

In addition to the portion of light generated by the LED light source 212 that travels through the first cavity 216 and impinges on the lens 218, another portion of the generated light, which in some embodiments can be about 70% of the light emitted by LED light source 212, travels through an inner sidewall 226 into the body portion 219 of the collimator. After being refracted at the inner sidewall, the light is reflected at a first outer wall having a reflective surface 229. In FIG. 2, the reflective surface 229 of the outer wall is depicted in an exaggerated manner to aid understanding. In general, according to various embodiments of the present invention discussed in greater detail below in connection with FIGS. 3 and 4, the reflective surface 229 of the outer wall may have an overall cross-sectional profile that essentially constitutes a spline, i.e., a piecewise polynomial function.

More specifically, in one exemplary embodiment as shown schematically in FIG. 2, the reflective surface 229 includes a plurality of segments 230, 221 and 232, wherein the respective segments have corresponding cross-sectional profiles defined by different low-order polynomial functions. Thus, from a three-dimensional perspective, each segment, or “sub-surface” of the overall reflective surface structure can be envisioned by rotating or sweeping about the central axis 225 a cross-sectional profile defined by a low-order polynomial, resulting in multiple annular sections of the collimator having different cross-sectional profiles, stacked one on top of another. In various implementations, the low-order polynomial defining any of the cross-sectional profiles of different segments of the reflective surface can be a first-, second-, third-, or fourth-order polynomials. For purposes of the discussion below, since the overall cross-sectional profile of the reflective surface 229 constitutes a spline, the reflective surface 229 is also referred to herein as a “spline reflective surface.”

In the specific example illustrated in FIG. 2, the sub-surfaces or segments 230, 231 have essentially linear cross-sectional profiles, while sub-surface 232 has an essentially parabolic cross-sectional profile. In general, the overall cross-sectional profile of a spline surface in accordance with the invention is defined as a piecewise polynomial function comprising different low-order polynomials. Respective low-order polynomials corresponding to cross-sectional profiles of adjacent segments are different from one another. Furthermore, as described in greater detail with reference to FIGS. 3-4, the segments are configured to substantially collimate light from the LED light source and, in many embodiments, are also configured to have smooth interconnections between adjacent segments/sub-surfaces. In the embodiment of FIG. 2, interconnecting regions 234 between adjacent segments are not smoothed out. The number of segments/sub-surfaces of the spline reflective surface can be adjusted to, for example, achieve the desired degree of control of the light. In many embodiments, the number of segments/sub-surfaces is a relatively small, finite number, such as within a range of 10-20. In this manner, the number of adjustments and calculations for determining the spline reflective surface is maintained at a reasonable number. Thus, conventional, off-the-shelf computer-aided design software programs, such as SOLIDWORKS® software available from SolidWorks Corporation (Concord, Mass.), can be used. The spline reflective surface of a collimator for an LED light source in accordance with the invention can be measured/imaged using scanning means, such as laser scanning or a touch probe technique. The data acquired from the scan can be entered into a CAD software program to aid in viewing the spline surface(s), such as by generating a point cloud, which can indicate the non-conic nature of the surface as well as other details of its configuration.

With respect to exemplary dimensions indicated in FIG. 2, in one particular embodiment, the collimator 200 has a height h of about 1 centimeter, and a maximum diameter d at second outer wall 222 of about 1.5 centimeters. In other embodiments, the height h is about 2 centimeters, and the diameter d is about 3 centimeters. In various embodiments of the invention, each of the segments of the spline reflective surface has a length l₁, l₂, or l₃ within a range of about 0.5 mm to about 2.0 mm. To achieve more precise control of light directionality, a greater density of segments/sub-surfaces can be provided at portions of the reflective surface where the overall slope of the cross-sectional profile is greater. For example, if the slope is higher near the end of the reflective surface closest to the light source, several sub-surfaces having shorter cross-sectional segments (for example, 0.5 mm in length each) can be provided there, while sub-surfaces having longer cross-sectional segments (for example, 2.0 mm in length each) can be provided toward the opposite end of the reflective surface, closest to the second outer wall, where the overall slope is lower. Thus, for example, in one embodiment of the invention, the spline reflective surface has ten segments/sub-surfaces: four sub-surfaces, which are near the light source, each having a 0.5 mm cross-sectional segment length; next and further up the spline, four sub-surfaces each having a 1 mm cross-sectional segment length; and two sub-surfaces, near the second outer wall, each having a 2 mm cross-sectional segment length.

In many embodiments of the invention, the spline surface is a smooth, free-form surface, free of sharp inflections or hooks, which can cause light incident thereon to be reflected in a direction substantially away from adjacent light.

Referring still to FIG. 2, in accordance with various embodiments of the invention, the inner sidewall 226 is gently sloped, so that it has no hooks or sharp inflections, and defines an angle, θ, with a vertical 227, which is within a range of about 5° to about 45°. This configuration maintains Fresnel losses to an acceptable level for many applications. The gently sloped, simple configuration of inner sidewall 226 can be made using simple molding and polishing steps, thereby providing a product that is highly reproducible.

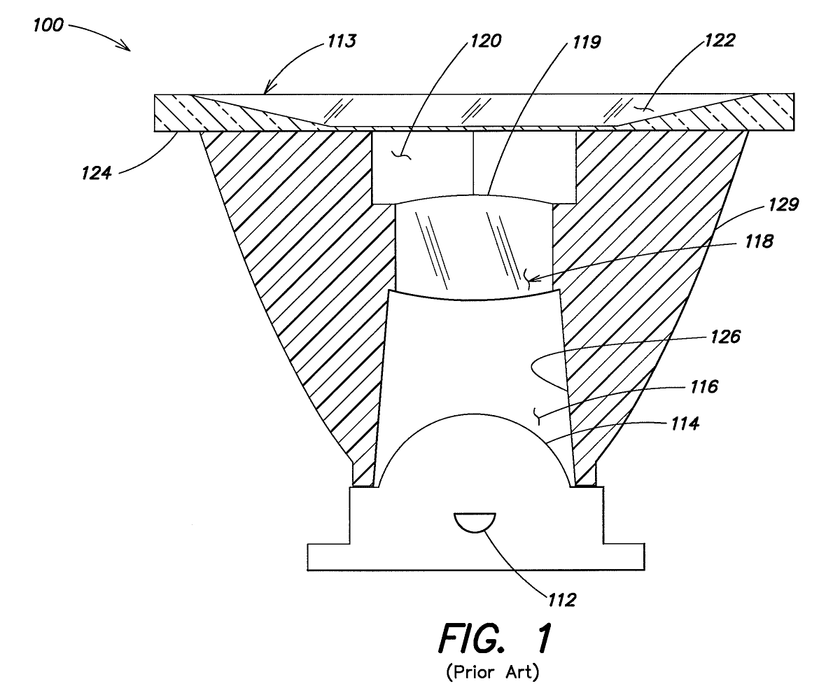

Referring to FIGS. 3-4, an exemplary method for configuring a collimator for an LED light source in accordance with the invention will be described. In particular, FIG. 3 is a cross-sectional view of a collimator, similar to that shown in FIGS. 1 and 2, to facilitate an explanation of a method for modifying a conventional collimator to provide an improved collimator according to one embodiment of the present invention, whereas FIG. 4 is a close-up view of a portion of a spline reflective surface of a collimator to facilitate an explanation of a method for improving smoothness of the reflective surface by employing a Bezier curve for at least a portion of the reflective surface's cross-sectional profile, according to one embodiment of the present invention.

More specifically, FIG. 3 illustrates steps for modifying a conventional conic TIR reflective surface so as to specifying different segments of a multi-segment reflective surface so as to substantially collimate light incident at the center points of the segments. These steps define selected tangents to an overall cross-sectional profile that results in a spline curve. FIG. 4 illustrates a method for providing smooth interconnecting regions between the respective segments/sub-surfaces of the spline reflective surface.

For the purpose of illustrating the inventive principles, FIG. 3 depicts light rays produced before and after the provision of the spline reflective surface of the invention. Accordingly, some features depicted in FIG. 3 draw upon aspects of the conventional collimator 100 shown as FIG. 1 which is used as a starting point for modification according to the present invention. For purposes of the following discussion, light emanating from the LED source 112 is depicted as a bundle 300 of multiple light rays 308, 310 and 312. In accordance with the invention, the reflective surface of a conventional collimator 100, having a generally parabolic cross-sectional profile, is modified so that the output light 302 emitted at the second outer wall 122 is collimated. In general, the directionality of the light is controlled, and, in the example of FIG. 3, the light is controlled to be perpendicular to a plane 304 just above the collimator. The solid line in output light 302 indicates a ray which retains the directionality that it had prior to the modification of reflective surface 129, while the dashed lines indicate rays for which the directionality has been modified by virtue of the modifications to the reflective surface.

In the example of FIG. 3, the desired directionality of the output light is selected to be substantially that of original light ray 310. Reflective surface 129 is therefore modified to adjust the directionality of the other light rays in light bundle 300. For ease of understanding, only the modification of exemplary light rays 308 and 312 in light bundle 300 will be described. In general, the original directionality of rays 308 and 312 are defined by the properties of LED light source 112. Their directionality when they travel through outer body portion 125 is determined in large part by the configuration of inner sidewall 126. The configuration of inner sidewall 126, for the purposes of determining the spline surface, is gently sloped, so that it has no hooks or sharp inflections, and defines an angle, θ, with a vertical 127 which is within a range of about 5° to about 45°.

In the method described with reference to FIG. 3, only TIR reflective surface 129 is adjusted in a segment-by-segment manner; inner sidewall 126 does not require fine-tuning. Providing the fine adjustments at reflective surface 129 results in a relatively larger area with which to work, per angle of emitted light, as compared with inner sidewall 126. In general, because the reflective surface is a relatively large, exterior surface, it is easier to manufacture and define using known tooling and molding methods.

In accordance with a method of the invention for fabricating a collimator for an LED light source, a TIR conic reflective surface is defined having a plurality of segments, wherein each of the segments has a center point and a tangent to the segment at the center point. In the embodiment of FIG. 3, the starting conic reflective surface is reflective surface 129. It is a short-focal-length, tipped parabola, in which the vertex of the parabola is rotated from a vertical line connecting it to the focus, through an angle within a range of 1-5°. This starting reflective surface is conceptually divided into multiple segments 314, each of which is defined by adjacent ones of points 318 along the cross-section of the reflective surface. Each segment has a center point, and the light incident at the center point is considered for the purposes of determining the modification to the reflective surface along the given segment.

First, the tangent to each segment at its center point is determined; then, the tangent is adjusted (tipped/tilted) to provide an adjusted tangent at the center point that would result, as dictated by the laws of reflection (angle of reflection equals the angle of incidence), in a light ray reflected from the center point having the desired directionality. That is, in accordance with the method of the invention, the center point tangent of each segment is adjusted to cause a light ray originating at the inner sidewall and incident on the center point of the segment to be substantially collimated upon exiting the collimator, thereby defining an adjusted tangent for each of the plurality of segments. For example, light ray 308 is incident at center point 326 at a lower segment 314 of the reflective surface. The tangent to the curve at point 326 is indicated by a solid line 320. Without modification to the tangent at point 326, ray 308 is reflected as indicated by a solid line in FIG. 3. To achieve a collimated ray, in accordance with the invention and as indicated by dashed line 322 in FIG. 3, the tip or tilt of the tangent is adjusted, so that ray 308, which is incident on point 326, will be reflected according to the laws of reflection to produce ray 322. A modified tangent 324, indicated by a dashed line in FIG. 3, thus derived is used to define the piecewise polynomial for a sub-surface of the spline surface centered at point 326.

Considering now ray 312, it is incident at a center point 327 of a segment 314 near the top of reflective surface 129. Without any modification to reflective surface 129, reflected ray 312, indicated by a solid line, deviates from a directionality that would make it parallel to ray 310 in the output light. To achieve the desired directionality, the tangent to the curve at point 327 is calculated, and its tip or tilt is adjusted, so that the directionality of the light ray, as indicated by dashed ray 328, is achieved to make it substantially parallel to ray 310. The modified tangent thus derived is used to define the polynomial for a segment/sub-surface of the spline reflective surface centered at point 327. In a manner similar to that described with reference to rays 308 and 312, other segments 314 can be analyzed and adjusted to define sub-surfaces of the spline reflective surface.

Segment 314, upon which ray 310 is incident at a center point 329, is not modified since it is not desired to change the directionality of ray 310. Therefore, the polynomial for the modified reflective surface about point 329 is defined by the unmodified tangent at center point 329.

After the tangents are thus defined by the constraints on the directionality of the output light, and in accordance with the method of the invention, a spline is generated by passing a curve through the plurality of center points and constrained by the plurality of tangents, including the adjusted tangents, as described above, thereby defining an overall cross-sectional profile of the reflective surface of the collimator, which includes different low-order polynomials defining profiles of respective segments. Curve-generating techniques using spline methods are available in conventional CAD software packages. In general, the spline surface of the collimator can be envisioned in three-dimensions by sweeping about a central axis of the collimator the spline curve.

Thus, a spline reflective surface in accordance with the invention provides control of the directionality of the light as it exits the collimator and is useful for realizing, for example, tight beam patterns. The second outer wall can also be a spline surface, defined by two or more different polynomials, which are selected to further collimate the light.

The description of FIG. 3 involves the adjustment or modification of a conventional reflective surface having a parabolic cross-section. In other embodiments of the invention, the initial surface upon which modifications are made is elliptical or hyperbolic. In these embodiments, the curve of the starting surface is similarly divided into segments and adjustments, similar to those described with reference to FIG. 3, are performed to determine the configuration of the spline reflective surface.

Furthermore, unlike prior art collimators, the angle of inclination of the second outer wall can be adjusted to prevent formation of a ring aberrations, glare, or halo effects in a light pattern of the light emitted by the lighting apparatus, without compromising on beam divergence. This is due to the adjustability provided by the spline reflective surface.

Referring to FIG. 4, in accordance with a method of the invention, the smoothness of the spline surface is further improved, particularly in the regions interconnecting the segments of the spline reflective surface. Increased smoothness improves collimation and reflection efficiency. To improve surface smoothness, steps are performed in addition to the adjustment steps described with reference to FIG. 3 for controlling the directionality of the light. In various methods of the invention, the smoothing is achieved using a Bezier spline curve technique. That is, the method further includes forming a Bezier curve from each pair of adjacent piecewise low-order polynomials. In general, after the modified tangent of one segment is determined in the manner described with reference to FIG. 3, the modified tangent is translated to configure it relative to an adjacent modified tangent, in a manner that smoothes out the spline curve in the region of inter-connection of the piecewise low-order polynomials. For example, using a Bezier technique, and referring to FIG. 4, the initial conic reflective surface has a first segment having end points E₁ and E₂ and a center point C₁; the adjacent segment has end points E₂ and E₃ and a center point C₂. Before any modifications, the initial tangent T₁, which is tangent to the first segment at C₁, intersects the initial tangent T₂, which is tangent to the second segment at C₂, at intersection I. Tangents T₁ and T₂ are modified in the manner described with reference to FIG. 3, to define adjusted tangents T₁′ and T₂′, which tangents intersect at I′. To improve the smoothness of the spline curve constrained by modified tangents T₁′ and T₂′, and in accordance to the Bezier technique, the point of intersection of the modified tangents is adjusted to be generally centered between C₁ and C₂. This can be done by translating C₂ along either a normal, N, to the second segment at C₂, or along a ray, R, defined by light incident at C₂. In the example of FIG. 4, C₂ and T₂′ are translated along R, to define a center point C₂′ and a tangent T₂″, which intersects T₁′ at I″, which is generally centered between C₁ and C₂′. The Bezier curve is then formed by generating a spline curve that passes through C₁ and C₂′, and is constrained by tangents T₁′ and T₂″. This Bezier curve is used to generate two sub-surfaces, having a smooth transition therebetween, of the reflective spline surface of an LED collimator in accordance with various embodiments of the invention. The two adjacent piecewise low-order polynomials thus derived in the regions of the two segments, together define the Bezier curve, which is free of sharp inflections or hooks.

In various examples, the adjustment procedure described with reference to FIG. 4 starts at the bottom of the conic curve and proceeds upwards along the curve, segment by segment, until the top-most segment is adjusted. The spline thus calculated may result in a diameter of the collimator that is too wide. To adjust the diameter, the modified, top-most segment can be moved to dispose the endpoint thereof at the desired location, and another iteration of the process described with reference to FIG. 4 can be performed, in a direction from top to bottom. Several one-way iterations can be performed in this manner to fine tune the diameter of the collimator. In certain examples, 15-20 one-way (up or down the curve) iterations are performed.

As is evident from the description of FIGS. 3-4, the method and apparatus of the invention includes consideration of the center points of a limited number of segments, rather than every point along the initial reflective surface, thereby improving the computational time for deriving the spline surface of the collimator.

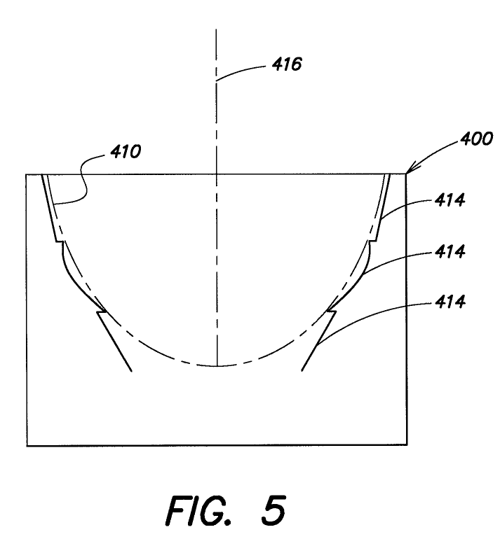

Referring to FIG. 5, a method for fabricating a collimator for an LED light source in accordance of the invention will now be described. The features of FIG. 5 are exaggerated to aid understanding. First, a steel block 400 is provided. As known to those skilled in the art, such a block is useful for forming in an injection molding tool. The steel block is shaped to form in the injection molding tool a generally parabolic surface. A bowl 410 is thus defined. Then, material is removed from the generally parabolic surface along a first depth less than the height of the bowl, along an annular portion of the bowl, to form a surface 414, which is the negative of/corresponds to a segment/sub-surface of a reflective spline surface. In a similar manner, multiple surfaces 414 can be created. In the example of FIG. 4, two of surfaces 414 have linear cross-sectional segments, and one of surfaces 414 has a parabolic cross-sectional segment. The injection molding tool having surfaces 414 is then filled with a molten polycarbonate material, which is thereafter hardened. In this manner the reflective spline surface is formed in the collimator.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. For example, while the description is generally directed toward substantially collimating light to be substantially parallel to a collimator's central axis, the invention provides control of the directionality of the light, so that in various embodiments the light is directed at an angle to the central axis of the collimator. As a further example, while the description is generally directed to a collimator having a circular horizontal cross-section, in various embodiments of the invention, the horizontal cross-section has a non-circular shape, such as an oval, so as to provide a variety of beam shapes. Accordingly, the foregoing description and attached drawings are by way of example only, and are not intended to be limiting.

What is claimed is:

1. A collimator for an LED light source, comprising:
an inner sidewall for receiving and refracting light generated by the LED light source;
a first outer wall for receiving and reflecting the light refracted at the inner sidewall, the first outer wall comprising a spline reflective surface having a cross-sectional profile at least partially defined by a spline, the spline being a piecewise polynomial function including a first low-order polynomial and a second low-order polynomial different from the first low-order polynomial, the first and second low-order polynomials being selected to achieve substantial collimation of the light reflected from the spline reflective surface; and
a second outer wall for receiving and transmitting the light reflected from the spline reflective surface.

2. The collimator of claim 1, wherein at least the first low-order polynomial is linear.

3. The collimator of claim 1, wherein at least the first low-order polynomial is quadratic.

4. The collimator of claim 1, wherein the spline includes from 10 to 20 low-order polynomials including the first and second low order polynomials.

5. The collimator of claim 1, wherein the first and second low-order polynomials are adjacent to one another and comprise a Bezier curve.

6. The collimator of claim 1, wherein the second outer wall has a diameter of about 1.5 cm.

7. The collimator of claim 1, wherein the collimator has a height of about 1 cm.

8. The collimator of claim 1, wherein the second outer wall comprises a second spline surface at least partially defined by a third low-order polynomial and a fourth low-order polynomial different from the third low-order polynomial, the third and fourth low-order polynomials being selected to achieve further collimation of the light reflected from the spline reflective surface.

9. The collimator of claim 1, wherein the second outer wall has a funnel shape.

10. The collimator of claim 1, wherein the cross-sectional profile of the spline reflective surface has a first cross-sectional segment defined by the first low-order polynomial and a second cross-sectional segment defined by the second low-order polynomial, each of the first and second cross-sectional segments having a length within a range of 0.5 mm to 2.0 mm.

11. A lighting module, comprising:
at least one LED light source; and
a collimator disposed to receive light emitted by the LED light source, the collimator comprising:
an inner sidewall for receiving and refracting light generated by the LED light source;
a first outer wall for receiving and reflecting the light refracted at the inner sidewall, the first outer wall comprising a spline reflective surface having a cross-sectional profile at least partially defined by a spline, the spline being a piecewise polynomial function including a first low-order polynomial and a second low-order polynomial different from the first low-order polynomial, the first and second low-order polynomials being selected to achieve substantial collimation of the light reflected from the spline reflective surface; and
a second outer wall for receiving and transmitting the light reflected from the spline reflective surface.

12. The lighting module of claim 11, wherein the second outer wall comprises a funnel surface.

13. A collimator for an LED light source and for emitting a collimator output light, the collimator comprising:
a body portion having:
an inner sidewall disposed to receive and refract the light generated by the LED light source, the inner sidewall at least partially defining a cavity;
a first outer wall for receiving and reflecting the light refracted at the inner sidewall, the first outer wall comprising a TIR spline surface having a plurality of sub-surfaces; and
a second outer wall for receiving and transmitting the light reflected from the TIR spline surface, wherein a first portion of the collimator output light exits the collimator at the second outer wall, and wherein the plurality of sub-surfaces of the TIR spline surface are configured to cause the first portion of the collimator output light to be substantially parallel to a central axis of the body portion; and
a lens contiguous with and surrounded by the body portion, the lens having an inner surface further defining the cavity.

14. The collimator of claim 13, wherein the TIR spline surface includes from 10 to 20 sub-surfaces.

15. The collimator of claim 13, wherein the lens has an outer surface and wherein the outer surface of the lens is texturized.

16. The collimator of claim 13, wherein a cross-section of the body portion taken perpendicular to the central axis is circular.

17. A collimator for an LED light source and for emitting a collimator output light, the collimator comprising:
a body portion having a central axis, the body portion comprising:
a first inner sidewall at least partially defining a first cavity and centrally disposed to receive and refract light from the LED light source, the first inner sidewall being disposed at an angle ranging from about 5° to about 45° from the central axis;
a first outer wall disposed to receive and reflect light refracted at the first inner sidewall, the first outer wall comprising a spline reflective surface comprising a plurality of sub-surfaces including at least one pair of adjacent sub-surfaces defined by different low-order polynomials;
a second outer wall comprising a transparent surface for receiving and transmitting light reflected from the spline reflective surface, a first portion of the collimator output light exiting the collimator at the second outer wall, the plurality of sub-surfaces of the spline reflective surface being configured to cause the first portion of the collimator output light to be substantially parallel to the central axis;
a flange contiguous with the transparent surface and at least partially encircling the transparent surface; and
a second inner sidewall contiguous with the transparent surface and at least partially defining a second cavity; and
a lens contiguous with and surrounded by the body portion, the lens having an inner surface further defining the first cavity and an outer surface further defining the second cavity, a second portion of the collimator output light exiting the collimator at the outer surface of the lens, wherein the lens is configured to cause the second portion of the collimator output light to be substantially parallel to the central axis.

18. The collimator of claim 17, wherein each of the plurality of sub-surfaces of the spline reflective surface defines a cross-sectional segment having a length ranging from about 0.5 mm to about 2.0 mm.

19. A method for configuring a collimator for an LED light source, the collimator having a reflective surface, the method comprising the acts of:
defining an inner sidewall disposed at an angle ranging from about 50 to about 45° from a central axis of the collimator for receiving and refracting light from the LED light source;
defining a conic TIR reflective surface for receiving and reflecting light from the inner sidewall;
dividing a cross-section of the conic TIR reflective surface into a plurality of segments, each of the segments having a center point and a tangent to the segment at the center point;
adjusting each tangent to cause a light ray originating at the inner sidewall and incident on the corresponding center point to exit the collimator substantially parallel to the central axis of the collimator, thereby defining an adjusted tangent for each of the plurality of segments; and
generating a spline curve passing through the plurality of center points and constrained by the plurality of adjusted tangents.

20. The method of claim 19, wherein the act of dividing a cross-section of the conic TIR reflective surface comprises dividing into segments a cross-section taken through the central axis, and wherein the act of generating a spline curve thereby defines a profile of the reflective surface of the collimator, the profile comprising a plurality of low-order polynomials.

21. The method of claim 19, wherein the act of dividing a cross-section of the conic TIR reflective surface comprises dividing into segments a cross-section taken perpendicular to the central axis.

22. The method of claim 19, further comprising the act of forming a Bezier curve from each pair of adjacent low-order polynomials, thereby providing smooth transitions between adjacent polynomials.

23. A collimator for an LED light source manufactured by the method of claim 19.

24. A collimator for an LED light source manufactured by the method of claim 20.
